(19) United States
(12) Patent Application Publication
(10) Pub. No.: US 2026/0054687 A1
(43) Pub. Date: Feb. 26, 2026

(54) Harness Integrated Crash Restraint System for Use on a Platform

(71) Applicant: The United States of America, as represented by the Secretary of the Navy, Arlington, VA (US)

(72) Inventors: Eric Anderson, Lexington Park, MD (US); Martin Lawson, Lexington Park, MD (US); Matthew Pontarelli, Lexington Park, MD (US); Aamir Jafri, Leonardtown, MD (US); Kelcy Seabolt, Leonardtown, MD (US); Nathaniel Owens, California, MD (US); Shannon Minnich, Drayden, MD (US); Nicholas Harris, California, MD (US); Peter Seidenberger, Great Mills, MD (US)

(21) Appl. No.: 18/809,876

(22) Filed: Aug. 20, 2024

(51) Int. Cl. B60R 22/26

(52) U.S. Cl. CPC B60R 22/26

(57) ABSTRACT

A harness integrated crash restraint system comprising a harness and a release mechanism. The harness is worn by an occupant in a platform, and includes a plurality of attachment points configured to connect with a plurality of seat restraint attachments attached to the platform, and webbing straps that wrap around the occupant's body such that when the harness is attached to the seat restraint attachments the occupant remains restrained to the platform and is safely decelerated during deceleration. The release mechanism allows the occupant to perform a single action to release the plurality of attachment points from the seat restraint attachments attached to the platform.

### STATEMENT OF GOVERNMENT INTEREST

The invention described herein may be manufactured and used by or for the Government of the United States of America for governmental purposes without payment of any royalties thereon or therefor.

### BACKGROUND

The invention provides an enhanced seat restraint system, method, and related equipment that reduce injuries and allows maximum flexibility for those who need tactical equipment affixed to their torso or waist, such as, but without limitation, military personnel, first responders, and the like.

The term platform, as used herein, includes all modes of mechanical transportation including, but not limited to, across the land, through the air, through space, on and under the water.

The term harness, as used herein, includes, but without limitation, any piece of equipment worn by a platform occupant or user that is adapted to attach to the platform as part of the occupant restraint system. A harness could therefore include, but without limitation, just a front panel with a harness, as well as having front, side and back panels, as well as webbing straps around the occupant's body.

Non-limiting examples of tactical equipment include a holstered firearm, a radio, a body camera, body armor, and pouches to hold gear, supplies, and ammunition.

It is to be understood that the descriptions provided herein are exemplary only and are not restrictive of the invention claimed.

Vehicles and platforms generally include safety features designed to protect occupants from injury in the event of sudden acceleration or deceleration (inertial forces). Automobile occupants may experience these sudden forces during a crash; aircraft occupants may also experience them during takeoffs, crashes, and landings. As a result, vehicles and platforms provide seating restraints to protect occupants from injury in the event of sudden accelerations or decelerations.

Current seat restraint systems are less than desirable for persons wearing tactical equipment at the waist and front torso because the restraints must pass over the equipment, separating the restraint from the body and lessening the efficacy of the system. In case of a crash, restraints must first tighten before providing the desired restrictive force. Restraints laying over tactical equipment have slack or are loosely-fitted, which delays the onset of the restraining forces. This delay decreases the amount of time that the restraining forces act on the body, increases the force necessary to dissipate the occupant's kinetic energy, and raises the likelihood and seriousness of injury.

While seat restraints unquestionably prevent deaths and reduce injuries, they can cause damage to a passenger/occupant via the transmission of force across the restraint. These injuries range, but without limitation, from bruising and abrasions to intra-abdominal injuries and vertebral fractures. The civilian used three-point adult harness rests on the shoulder, chest, and abdomen. During impact, the restraints can transmit significant force causing damage to the neck, chest, abdomen, and internal organs. The present invention utilizes a harness integrated crash restraint system that distributes the restraining force across a larger area of the torso and, thus, reduces injuries caused by restraining belts.

Crash energy mitigation in automobiles is achieved by incorporating load-attenuating deformable structures such as padded dashboards, collapsible steering columns, and airbags. Such deformable structures are less applicable to military platforms such as aircraft, ground vehicles, and other military platforms. The occupants of military vehicles or platforms are exposed to rapid vertical forces not present in the civilian sector. Military ground vehicles are also subjected to these forces by anti-vehicle mines or other explosive devices encountered in combat. Many military vehicles or platforms, particularly aircraft, use a five- or six-point seat restraint system. These include shoulder, lap, and crotch belts or webs coupled to a buckle assembly. While the 5-point system helps dissipate the restrictive force across a broader area of the user's body, it suffers from the drawback of being even a greater infringement on torso-mounted tactical gear.

Conventional methods and systems have generally been considered satisfactory for their intended purpose. The increased maneuvering capability of present and future high-performance military aircraft and platforms expose crew members to even greater accelerations than before in all three dimensions, front-back, vertical, and lateral. Thus, there remains a need in the art for a restraint system that is operable with torso-mounted tactical equipment without sacrificing safety and efficiency.

### SUMMARY

The present invention is directed to a harness integrated crash restraint system with the needs enumerated above and below.

The present invention is directed to a harness integrated crash restraint system comprising a harness worn by an occupant in a platform, the harness includes a plurality of attachment points configured to connect with a plurality of seat restraint attachments attached to the platform, the harness further comprises webbing straps that wrap around the occupant's body such that when the harness is attached to the seat restraint attachments the occupant remains restrained to the platform and is safely decelerated during deceleration; and, a release mechanism wherein the occupant can perform a single action to release the plurality of attachment points from the seat restraint attachments attached to the platform.

The present invention provides a harness integrated crash restraint system that is operable with torso-mounted tactical equipment without sacrificing safety and efficiency.

The present invention provides a system with a restraint harness worn beneath a tactical harness. The present invention is fully operable with reel and torso retraction systems, which allow occupants to move when there are no excessive accelerations present but lock when high accelerations are sensed. This invention also improves upon conventional systems by dissipating the restrictive force across the entire torso, not only where belts come into contact with the occupant.

### DRAWINGS

These and other features, aspects and advantages of the present invention will become better understood with reference to the following description and appended claims, and accompanying drawings wherein:

FIG. 1A shows a side view of the harness integrated crash restraint system;

FIG. 1B shows a front view of the harness integrated crash restraint system;

FIG. 2A shows a side view of another embodiment of the integrated crash restraint system;

FIG. 2B shows a front view of another embodiment of the integrated crash restraint system;

FIG. 2C shows a back view of another embodiment of the integrated crash restraint system;

FIG. 3A shows a side view of an embodiment of the harness integrated crash restraint system;

FIG. 3B shows a front view of an embodiment the harness integrated crash restraint system; and,

FIG. 4 is a graph showing z axis displacement versus y axis displacement of a conventional 5-point restraint and a harness integrated crash restraint.

### DESCRIPTION

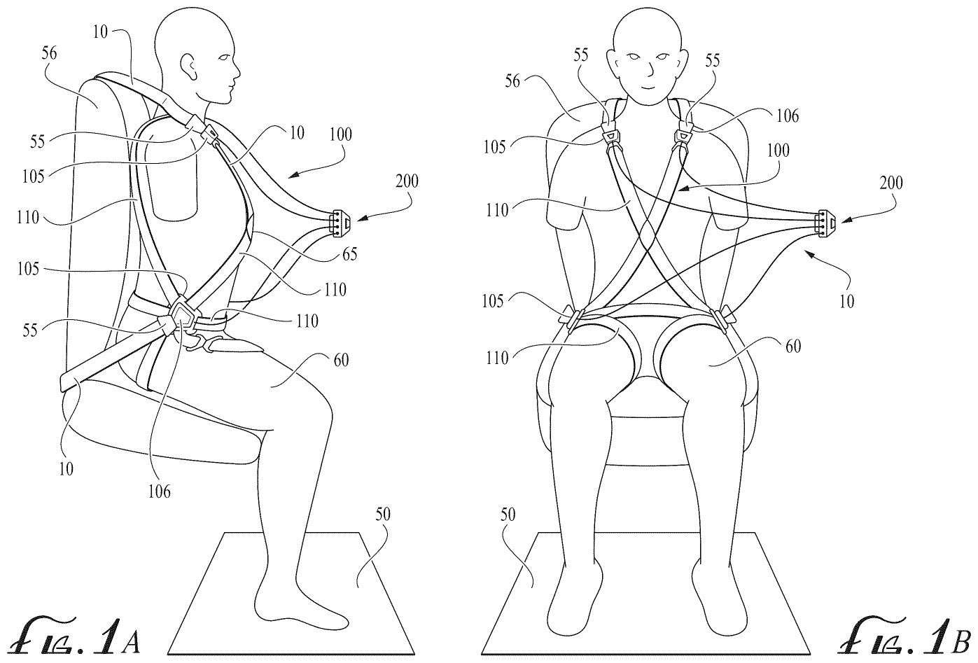

The preferred embodiments of the present invention are illustrated by way of example below and in FIGS. 1-4. The invention is a harness integrated crash restraint system 10 for use on a platform 50. The system 10 includes a harness 100 worn by an occupant 60 in a platform 50 (partially shown) and a release mechanism 200. The harness 100 includes a plurality of harness attachment points 105 configured to connect with a plurality of seat restraint attachments 55 attached to the platform 50 (or to the platform seat 56), particularly attached to a platform seat 56. The harness further 100 includes webbing straps 110 that wrap around the occupant's 60 body such that when the harness 100 is attached to the seat restraint attachments 55 the occupant 60 remains restrained to the platform 50 and is safely decelerated during deceleration (in particular, protected from any inertial forces placed on the occupant 60). The release mechanism 200 allows the occupant 60 to perform a single action to release the plurality of harness attachment points 105 from the seat restraint attachments 55 attached to the platform 50.

In the description of the present invention, the invention will be discussed in a military environment; however, this invention can be utilized for any type of application that utilizes a restraint system.

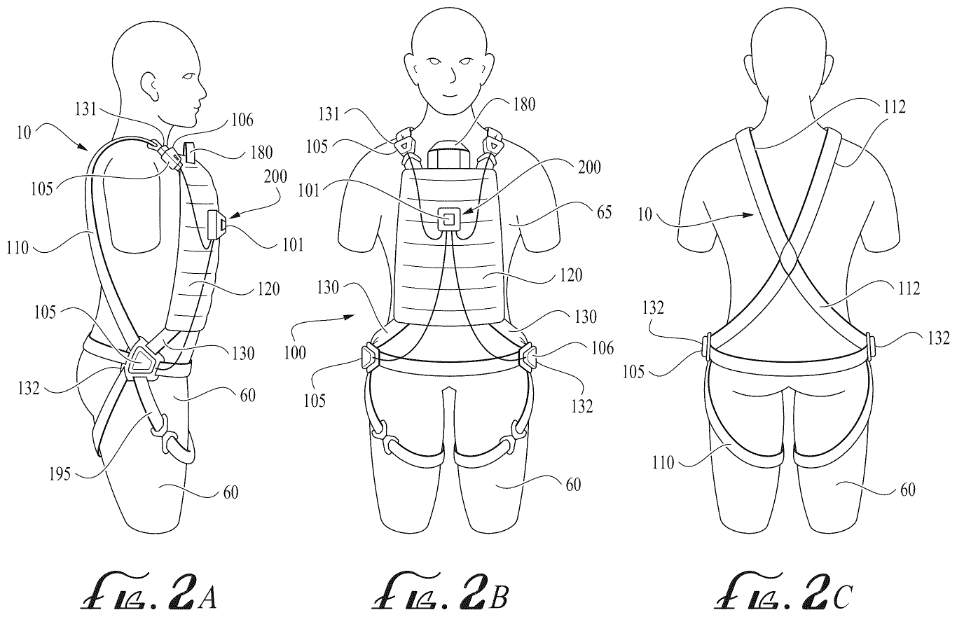

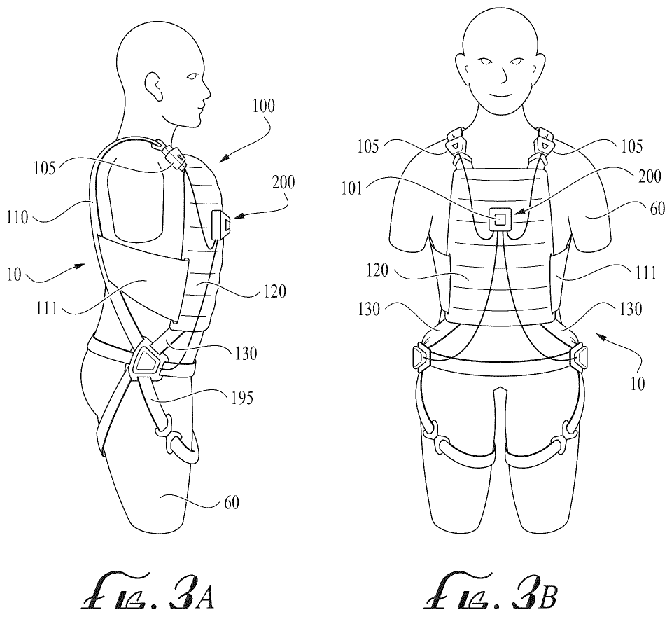

As shown in FIGS. 2A, 2B, 3A, and 3B, the occupant 60 includes a front torso 65 and the harness 100 may include a front panel 120 covering a portion the front torso 65 of the occupant 60.

One embodiment of the invention is a restraint system 10 for an occupant 60 of a platform 50 where the occupant 60 may experience vertical or horizontal accelerative or decelerative forces sufficient to cause injury. The restraint system 10 includes a harness 100 worn by the occupant 60 that includes at least one attachment point 105 for connecting the harness 10 to the platform frame, or other structural components. The attachment point(s) 105 can be specialized for use with the harness 100, or configured for providing improved crash restraint over existing systems. The invention also allows the harness 100 to be custom fit to the user/occupant 60 if desired, thus making it even more effective at reducing injury. The harness integrated crash restraint system 10 of the current invention permits users the option of attaching tactical equipment to the harness 100 itself or wearing a tactical harness over the restraining harness 100.

Another embodiment of the invention is a method of reducing injury to occupants 60 of a vehicle or platform 50 where the occupant 60 may experience vertical or horizontal accelerative or decelerative forces sufficient to cause injury. The method includes the use of a harness 100 worn by the occupant 60 that has at least one harness attachment point 105 for connecting the harness 100 to the platform seat 56. The harness attachment point(s) 105 can be specialized for use with the harness 100, or configured for use with existing restraint systems. The method of the present invention provides improved crash restraint over existing methods. The invention also allows the harness 100 to be custom fit to the user/occupant 60, thus making it even more effective at reducing injury. The method of the current invention permits users the option of attaching tactical equipment to the harness 100 itself or wearing a tactical harness over the restraining harness.

The harness 100 may be, but without limitation, generic, sized for different body types, or custom fit to each user/occupant. Optionally, the harness 100 is configured to allow tactical equipment to be attached directly to the harness 100, or it can be worn in conjunctions with a tactical vest.

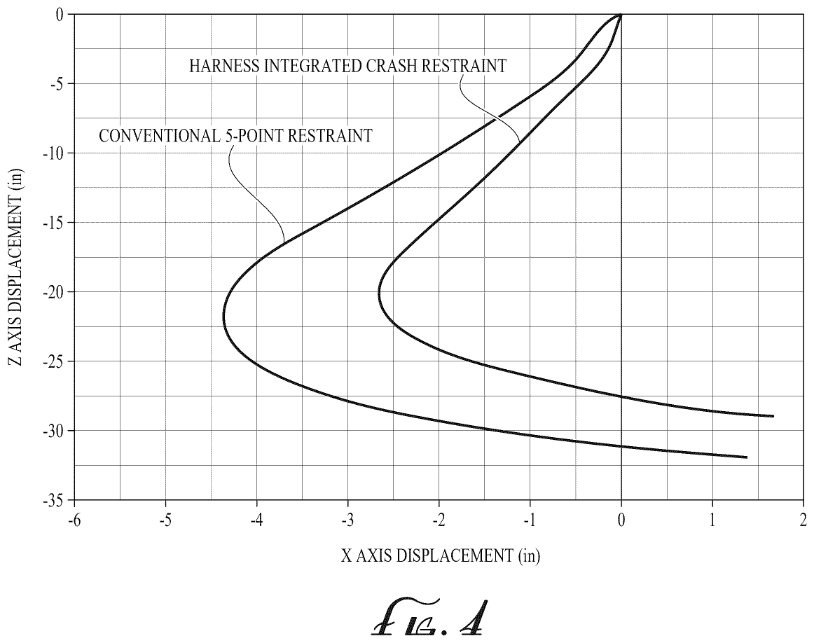

To measure the improved effectiveness of the harness integrated crash restraint system 10 over conventional systems, a head-flail study was performed using a series of Finite Element Analysis (FEA) simulations. ANSYS LS-DYNA® from Ansys Inc. of Cannonsburg, Pennsylvania was used to generate the data depicted in FIG. 4. A model of the Sikorsky MH-65 helicopter gunner seat attached to a fixture deigned for Pure Vertical testing, was built and validated using horizontal-accelerator testing protocol. A Fast HYBRID III 50th Percentile model produced by Livermore Software Technology Corporation was used. The test condition used to study the impact of the current invention was a modified combined vertical load condition (the seat was pitched forward 30 degrees). This model was simulated with a conventional 5-point restraint system and with the system of the current invention, and physical prototypes were tested in a laboratory environment. The head displacement data was collected by tracking the displacement of the node at the top the model's head, relative to the fixture. The results showed a 3.5 inch reduction in head-flail when the system of the current invention was used as compared to the conventional 5-point restraint. This indicates the superiority and improved safety of the harness integrated crash restraint system 10 over currently available and currently used restraint systems.

As would be apparent to those of skill in the art, the harness 100 of the harness integrated crash restraint system 10 can take many shapes or configurations and still achieve the desired enhanced restraining results. It is preferred that the harness 100 covers the front torso of the wearer/occupant 60 from at least just below the collarbone to the base of the sternum to ensure the retraining forces are distributed across the wearer's front torso. However, any configuration that covers a portion of the front torso 65 of an occupant 60 can be utilized.

As described earlier, the harness 100 includes at least harness one attachment point 105 so it can be affixed to the vehicle or platform 50 to form an overall seat restraint system. Preferably, the harness 100 includes multiple harness attachment points 105. Most preferably, the harness 100 includes harness attachment points 105 at each shoulder and at each hip.

The at least one harness attachment point 105 can be any method or apparatus of securing the harness 100 to the remaining portion of the harness integrated crash restraint system 10. Preferably, as shown in FIGS. 1A, 1B, 2A, and 2B buckles 106 are used as the harness attachment point 105. However, any method or apparatus that is practicable can be utilized.

As shown in FIGS. 2A and 2B, a single action release mechanism 101 can also be part of the harness 100.

In one of the preferred embodiments, as shown in FIGS. 2A, 2B, 3A and 3B, the harness integrated crash restraint system 10 may include a harness 100 either attached to the front panel 120 of the harness 100, or can have harness straps 130 pass incorporated into and passing through the front panel 120 of the harness 100. In another preferred embodiment, shown in FIGS. 2A, 2B, and 2C, webbing straps 110 connect each shoulder attachment point 131 to a hip attachment point 132 on the opposite hip crossing over the torso on the front and back of the wearer or occupant 60. Additional webbing straps 110 connect the two hip attachment points 132 across the wearer's waist, forming a loop around the waist. Additional webbing straps 110 form loops around the wearer's legs. Additionally, as shown in FIGS. 2A and 2B, webbing cords 180, straps, or loops may be integrated into the harness 100, for example, but without limitation, on the chest and back, for attachment to fall-protection and hoist devices.

In one embodiment, the harness 100 is configured so the wearer/occupant 60 pulls it over their head. In an alternate embodiment, the harness may be configured so the wearer/occupant 60 can open it, as an overlay, and close it around themselves using any typical method of closure such as, but without limitation, zippers, snaps, clips, hook and pile attachment, or any of the equivalents.

In another embodiment, the harness 100 completely encircles a portion of the upper torso of the wearer/occupant 60 when properly worn. Alternatively, as shown in FIGS. 3A and 3B, the harness 100 could include a front panel 120 with straps 111 on the back and sides. In one alternate embodiment, as shown in FIG. 2C, diagonal straps 112 pass from one shoulder to the opposite hip, forming an “x” across the back of the wearer. Any combination of horizontal, vertical, diagonal straps, or combinations thereof can be used.

The harness 100 includes at least one harness attachment point 105 to affix it to the remaining portion of the seat restraining system 10. The harness attachment point 105 can include, but without limitation, buckles, straps, clips, or the equivalent provided they have sufficient strength to withstand the restraining forces. Any method or apparatus that is practicable can be utilized to perform this function. More preferably, the harness 100 has multiple harness attachment points 105. Even more preferably, the harness 100 has a harness attachment point at the shoulder and at each side of the harness near the wearer's hips. Most preferably, the harness 100 will also include a release mechanism 200 that is single action release and in communication with the attachments.

The harness 100 can be constructed of any material known in the art, taking into account, but without limitation, durability, wearability, comfort, and ease of fabrication. The harness 100 can be constructed, but without limitation, of a single layer, or multiple layers sewed or bonded together.

Optionally, the harness 100 can include additional horizontal, vertical, and/or diagonal strengthening members, such as straps, belts and the like. As shown in FIG. 3A, for better fit, the harness 100 may also include adjustment straps 195 to tighten it around the wearer. The harness 100 may also incorporate padding for wearer comfort. The harness 100 can also be configured to so that tactical gear may be affixed to it.

It is understood that this invention improves current seat restraint systems by incorporating a harness that can be coupled to attachment points affixed to the vehicle or the seat. Thus, this invention takes advantage of current advances in restraints, such as inertial reels and tensioning systems which allow the occupant certain mobility during normal operation, absent an emergency.

This invention is particularly well suited for law enforcement and military platform restraint systems. Additional uses, such as, but without limitation, in sports vehicles, will be understood by one of ordinary skill as an aspect of this invention.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A harness integrated crash restraint system for use on a platform, the system comprising:
a harness worn by an occupant in a platform, the harness includes a plurality of attachment points configured to connect with a plurality of seat restraint attachments attached to the platform, the harness further includes webbing straps that wrap around the occupant's body such that when the harness is attached to the seat restraint attachments the occupant remains restrained to the platform and is safely decelerated during deceleration; and,
a release mechanism wherein the occupant can perform a single action to release the plurality of attachment points from the seat restraint attachments attached to the platform.

2. The system of claim 1, wherein the occupant having a front torso and the harness including a front panel covering a portion the front torso of the occupant.
